(19) United States
(12) Patent Application Publication
(10) Pub. No.: US 2007/0143414 A1
(43) Pub. Date: Jun. 21, 2007

(54) Reference links for instant messaging

(76) Inventor: Brian K. Daigle, Marietta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/304,177

(22) Filed: Dec. 15, 2005

(51) Int. Cl. G06F 15/16

(52) U.S. Cl. 709/206

(57) ABSTRACT

Embodiments discussed in this disclosure can be configured to provide for including a reference link in an instant message by a sender for a recipient includes receiving an identifiable character string in the instant message, the identifiable character string being associated with an entity, determining an entity type that is associated with the entity, and retrieving information related to the entity. Other embodiments of the method include creating a reference link that associates the identifiable character string with the information related to the entity and including the reference link in the instant message. Other methods and devices are also provided.

### BACKGROUND

With the advent of the Internet, different forms of digital communications have recently appeared. Examples of such digital communications include email and instant messaging (IM). Often in instant messaging, one user communicates with another user in near real time. While instant messaging can provide an extremely fast communications medium, the amount and types of data that are communicated can be limited.

Currently, instant messaging users can communicate text messages to other instant messaging users and receive text messages from other instant messaging users. While users can attach files and other data within a text message, there is limited capability for users to communicate additional information within the text message. Additionally, instant messaging senders currently do not have the ability to easily link current information to an instant message such that an instant messaging recipient can easily view and access the data of interest.

Thus, a heretofore unaddressed need exists in the industry to address the aforementioned deficiencies and inadequacies.

### SUMMARY

Included are methods for including a reference link in an instant message by a sender for a recipient. Embodiments include receiving an identifiable character string in the instant message, the identifiable character string being associated with an entity; determining an entity type that is associated with the entity; retrieving information related to the entity; creating a reference link that associates the identifiable character string with the information related to the entity; and including the reference link in the instant message.

The disclosure also includes embodiments of a computer readable medium having a program for including a reference link in an instant message by a sender for a recipient. One embodiment of the computer readable medium, among others, includes logic configured to receive an identifiable character string in the instant message, the identifiable character string being associated with an entity and logic configured to determine an entity type that is associated with the entity. Embodiments of the computer readable medium also include logic configured to retrieve information related to the entity, logic configured to create a reference link that associates the identifiable character string with the information related to the entity, and logic configured to include the reference link in the instant message.

Other systems, methods, features, and advantages of this disclosure will be or become apparent to one with skill in the art upon examination of the following drawings and detailed description. It is intended that all such additional systems, methods, features, and advantages be included within this description, be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

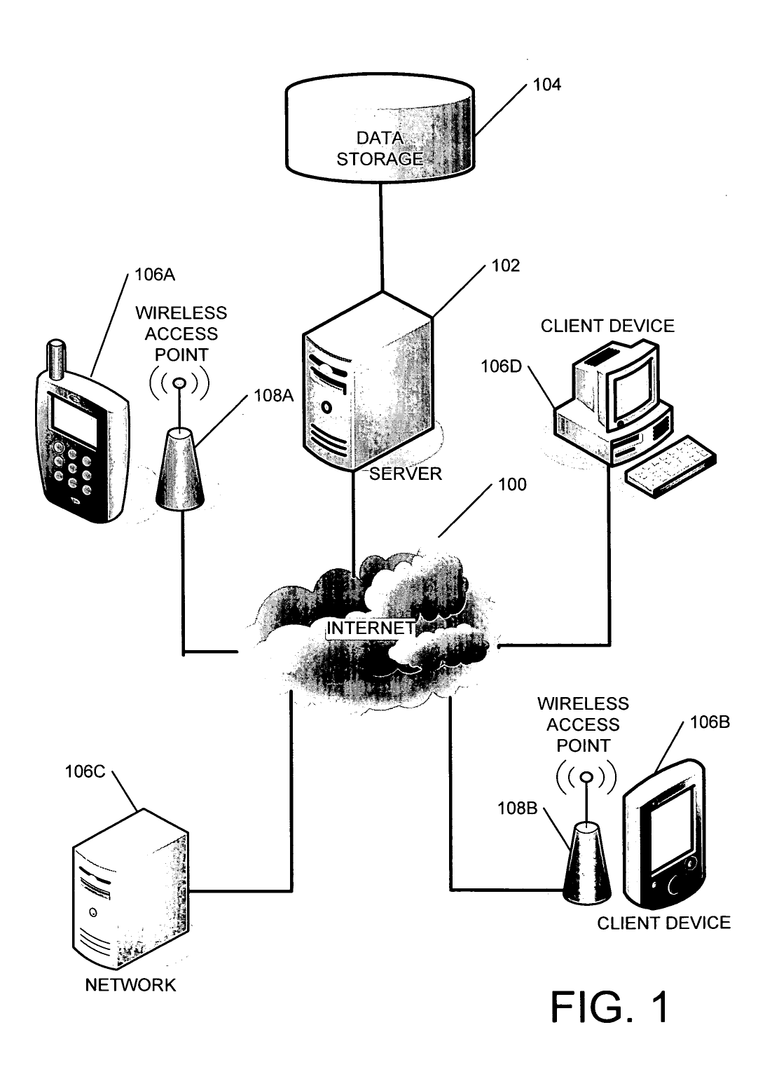

FIG. 1 is a functional diagram of an exemplary instant messaging network environment.

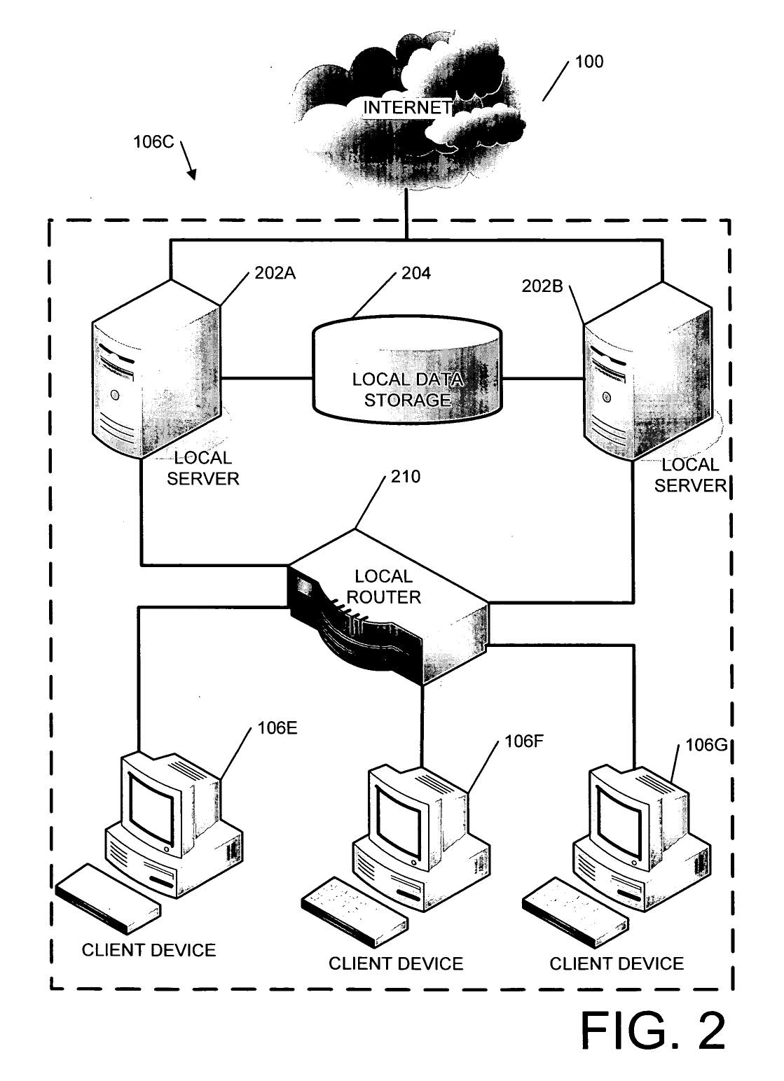

FIG. 2 is a functional diagram of an exemplary local network environment by which a user can send an instant message, similar to the environment from FIG. 1.

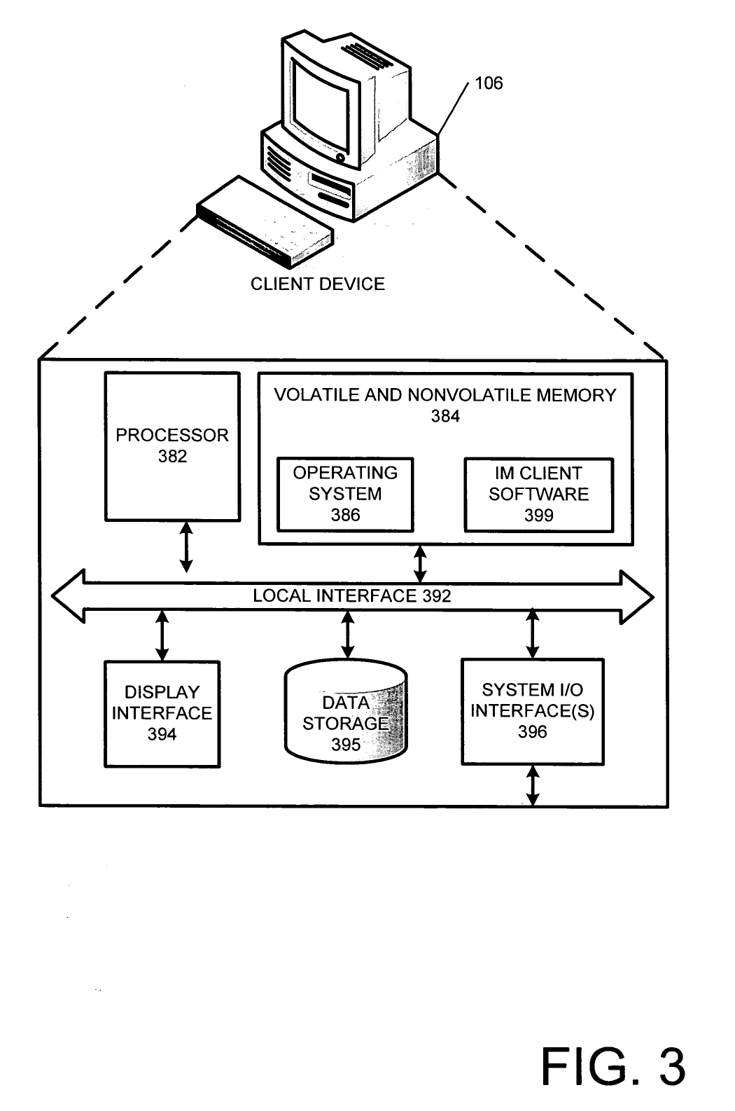

FIG. 3 is a functional diagram illustrating an exemplary embodiment of a client device that may be configured to communicate via a communications network, such as the networks from FIGS. 1 and 2.

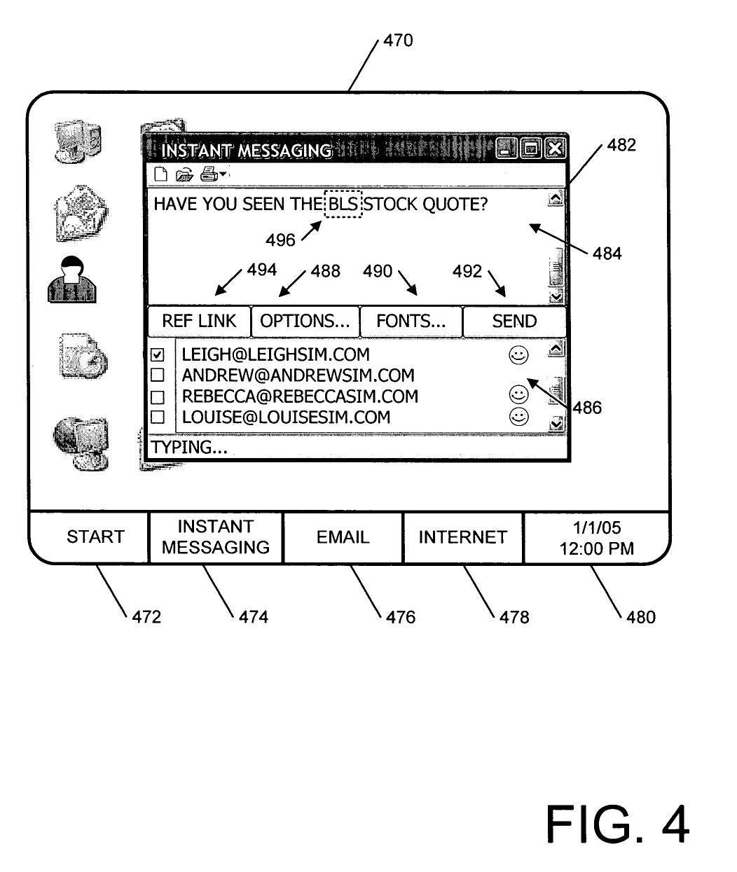

FIG. 4 is an exemplary display for the instant messaging client software discussed with reference to FIGS. 1 and 2.

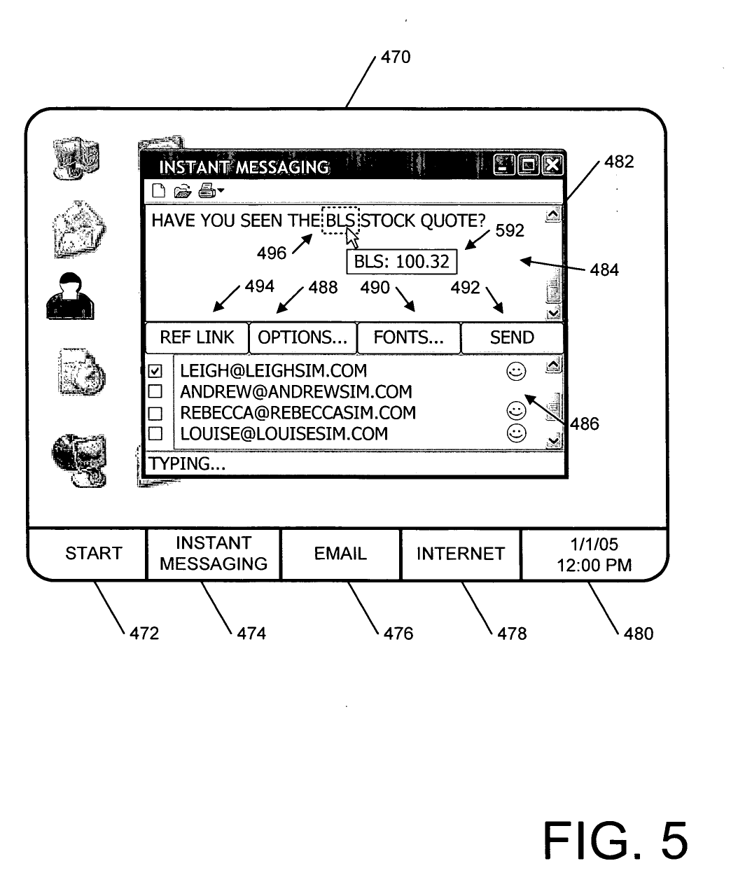

FIG. 5 is an exemplary display for the instant messaging client software with a reference link, such as the reference link from FIG. 4.

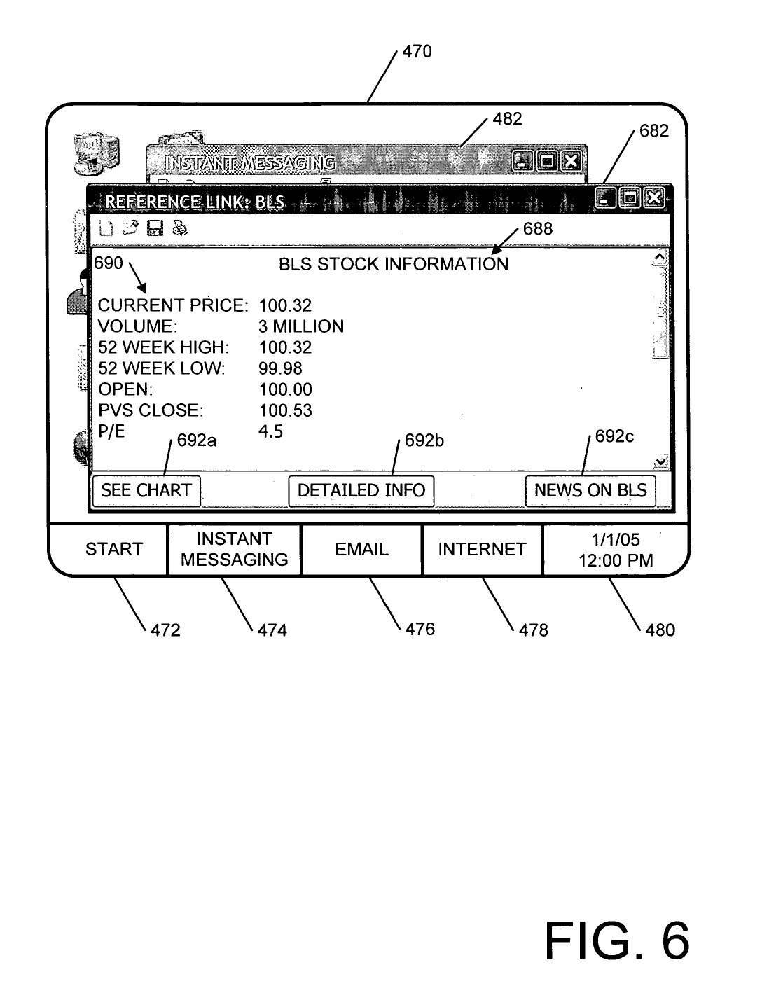

FIG. 6 is an exemplary display for the instant messaging client software in response to an event related to the reference link from FIG. 4.

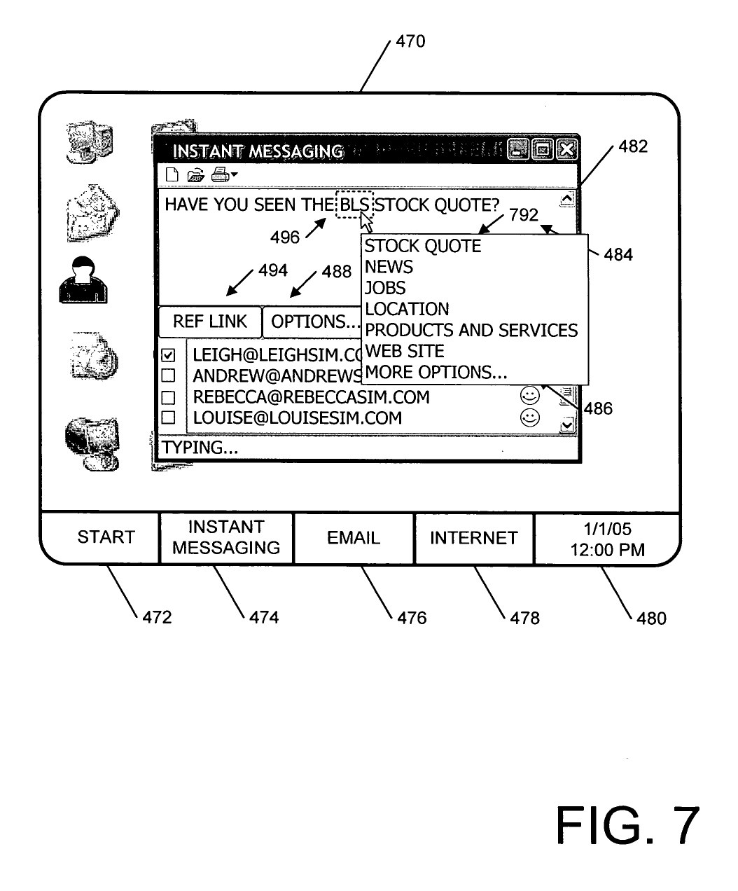

FIG. 7 is an exemplary display for instant messaging client software, similar to the display from FIG. 4.

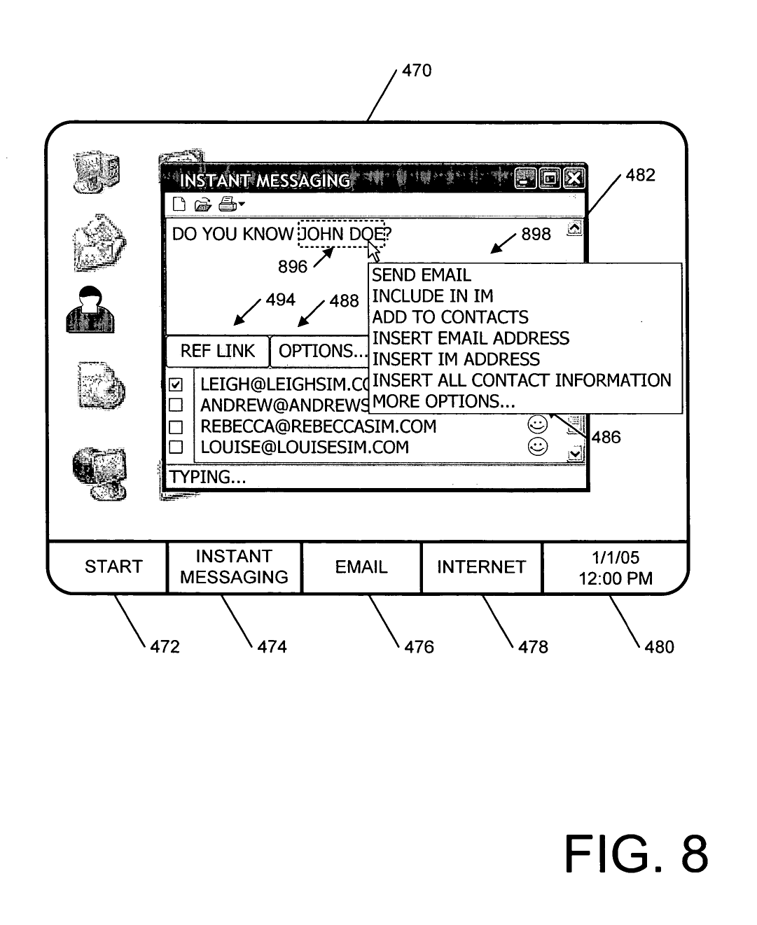

FIG. 8 is an exemplary display of a plurality of personal reference link options, similar to the reference link options from FIG. 7.

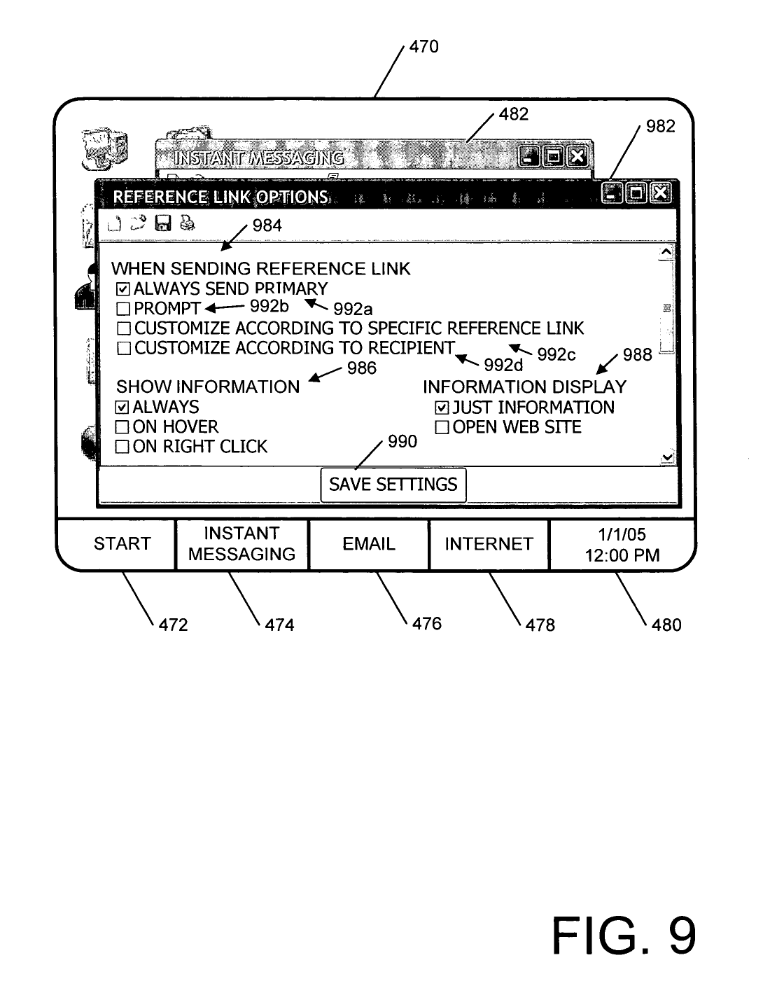

FIG. 9 is an exemplary display of a reference link options page that can be accessed by selecting the “REF LINK” option from FIG. 4.

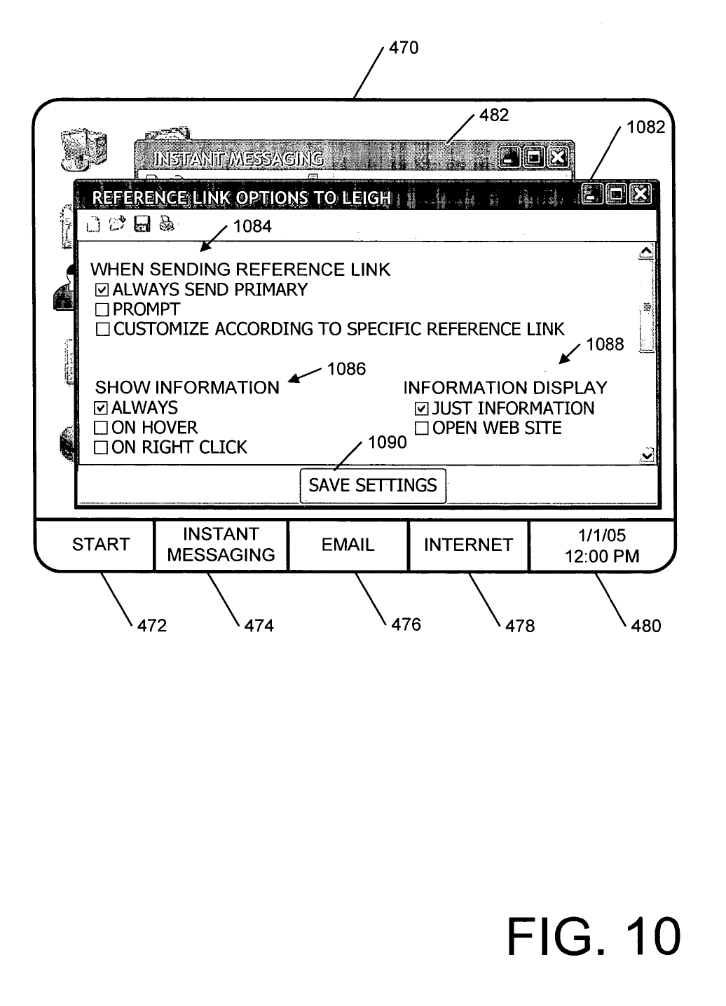

FIG. 10 is an exemplary display of a reference link options page for a recipient window, similar to the display from FIG. 9.

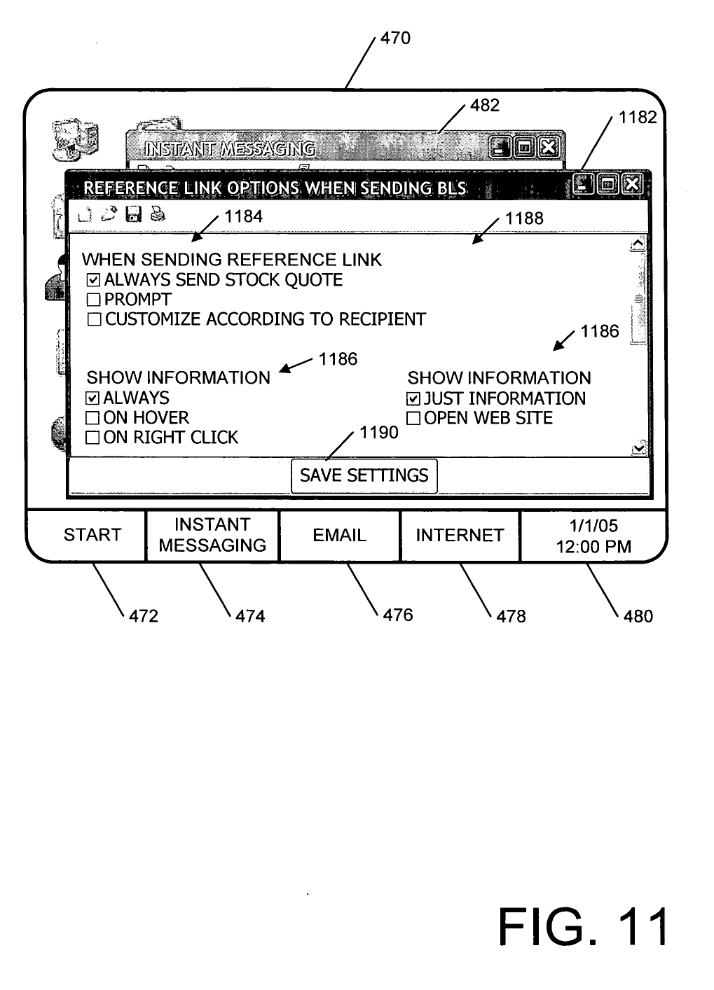

FIG. 11 is an exemplary display of a reference link options page for a reference link window, as shown in the display from FIG. 9.

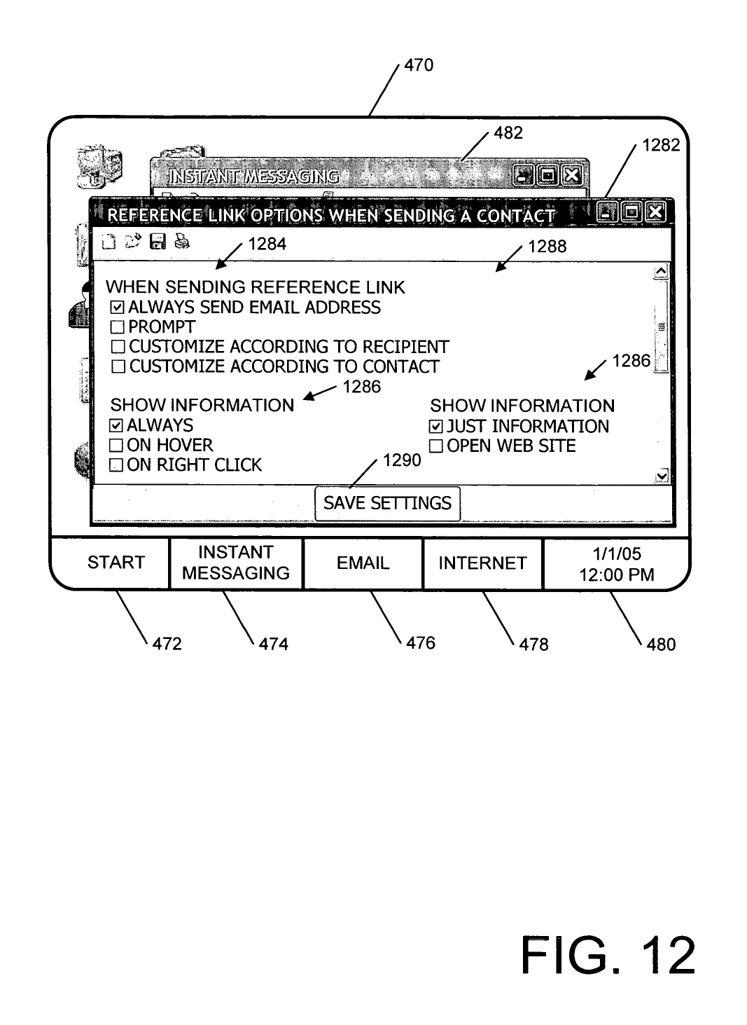

FIG. 12 is an exemplary display of a reference link options page when sending particular information window, similar to the display from FIG. 11.

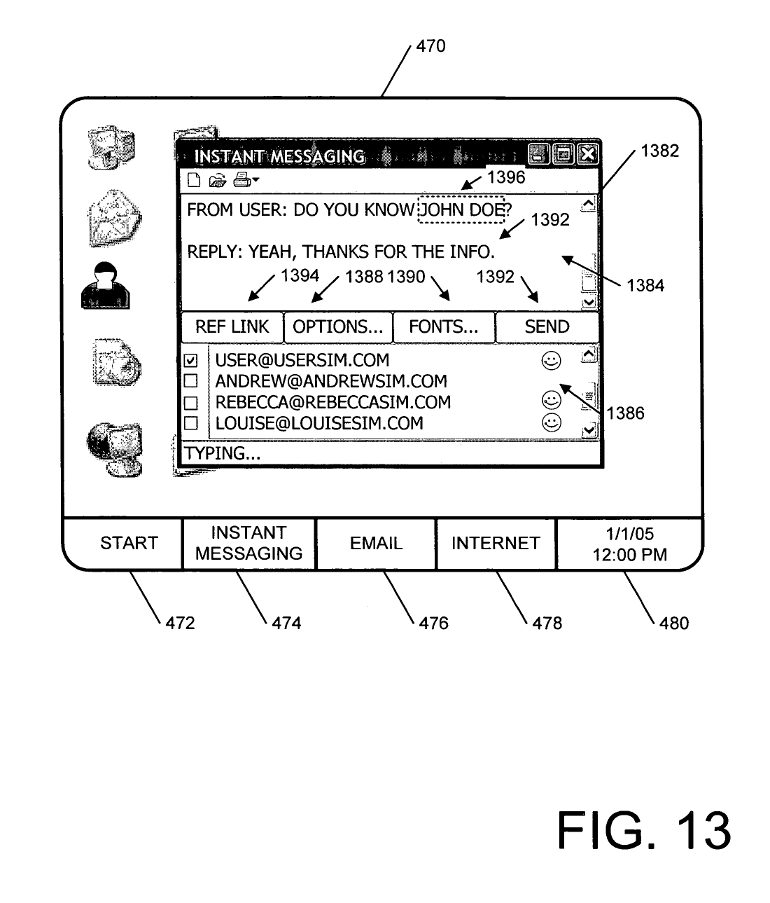

FIG. 13 is an exemplary display of an instant messaging window for a instant message recipient, similar to the instant messaging window from FIG. 4.

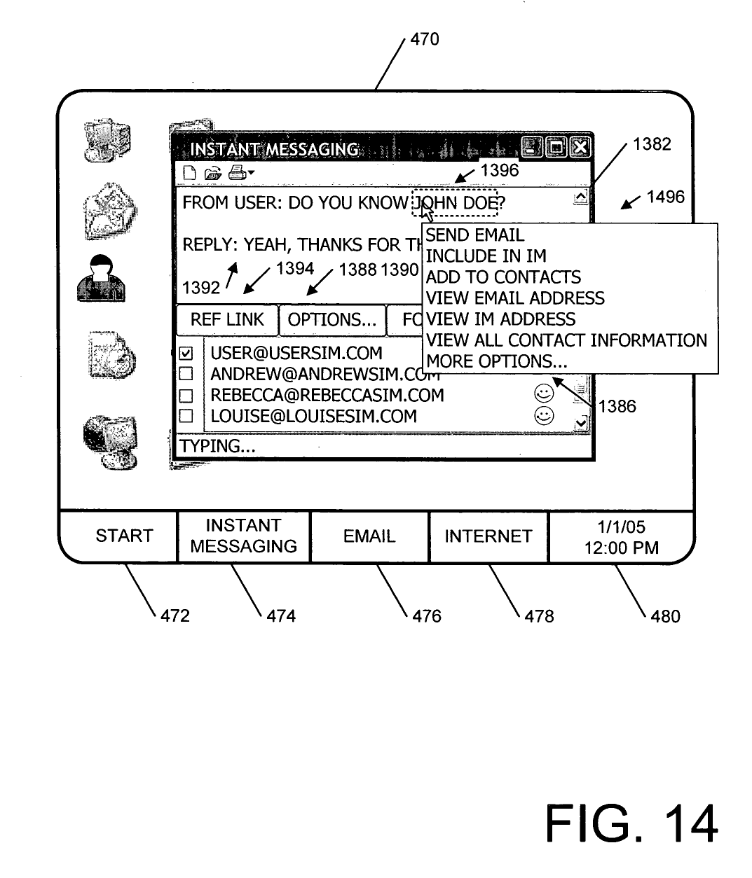

FIG. 14 is an exemplary display for the instant messaging client software, similar to the display from FIG. 8.

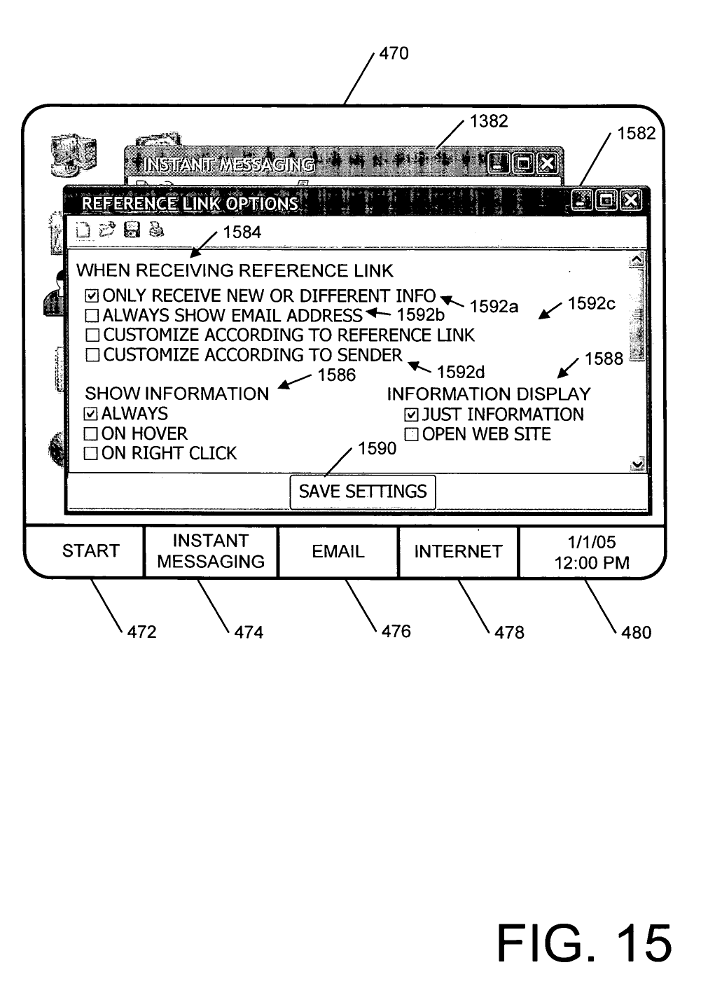

FIG. 15 is an exemplary display of a reference link options page that can be accessed by the recipient selecting the “REF LINK” option from FIG. 13.

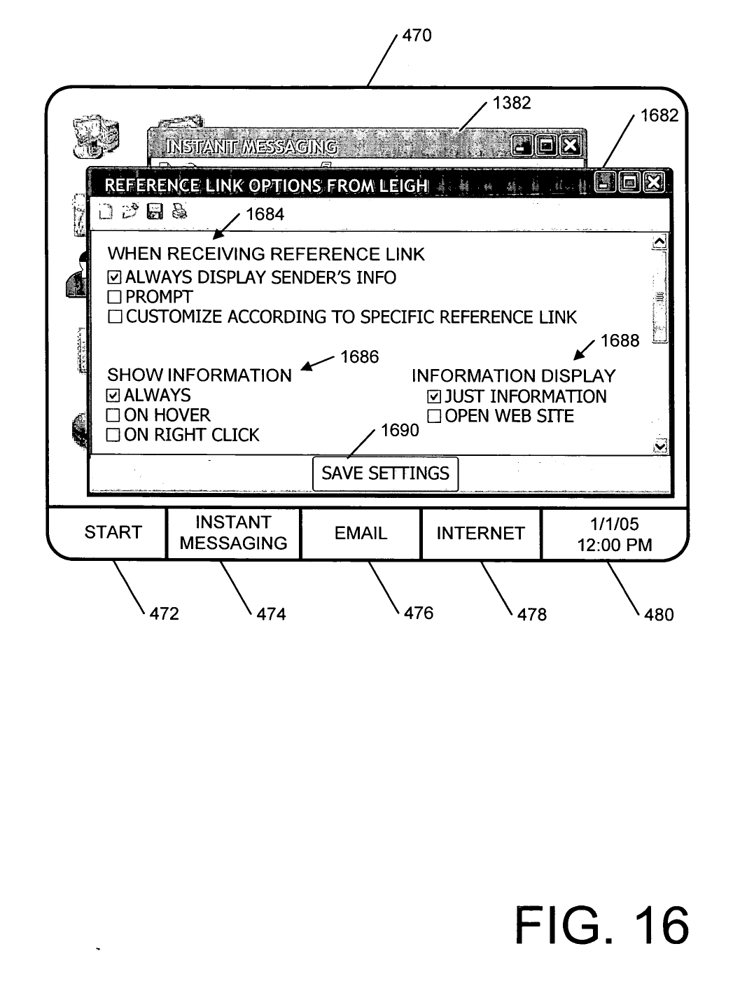

FIG. 16 is an exemplary display of a reference link options page from a sender window, similar to the display from FIG. 15.

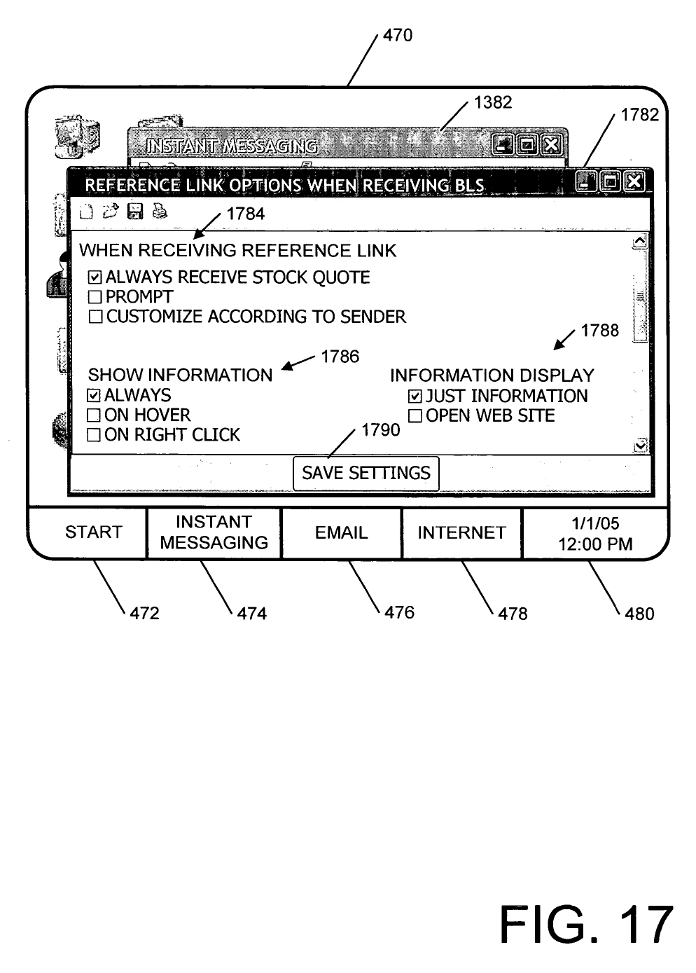

FIG. 17 is an exemplary display of a reference link options page from a sender window, similar to the display from FIG. 16.

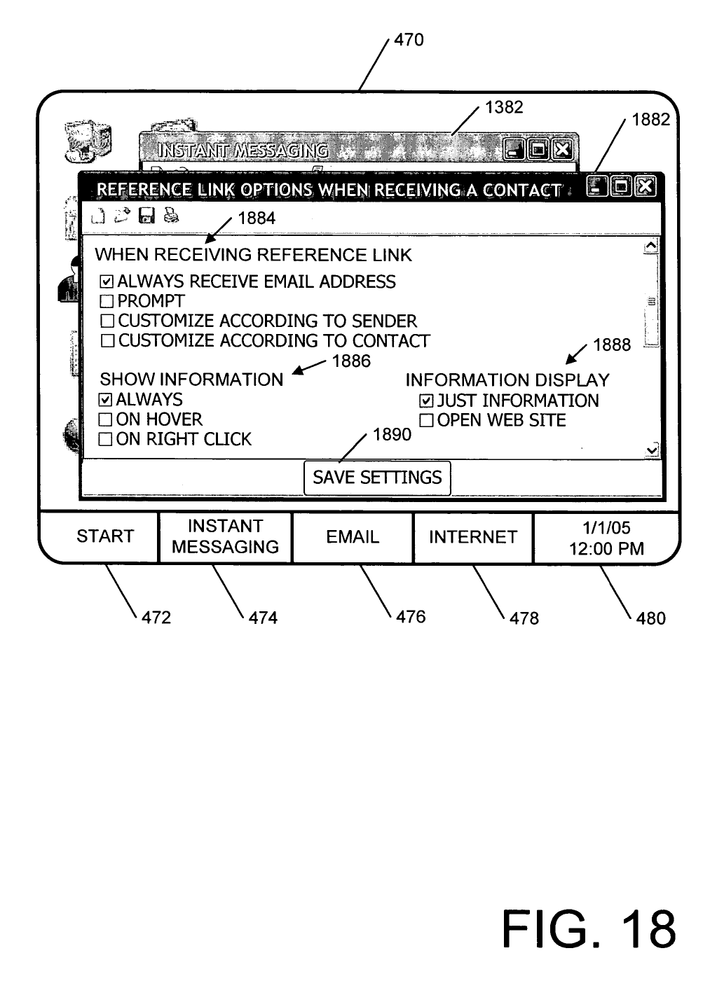

FIG. 18 is an exemplary display of a reference link option when receiving particular information window, similar to the display from FIG. 17.

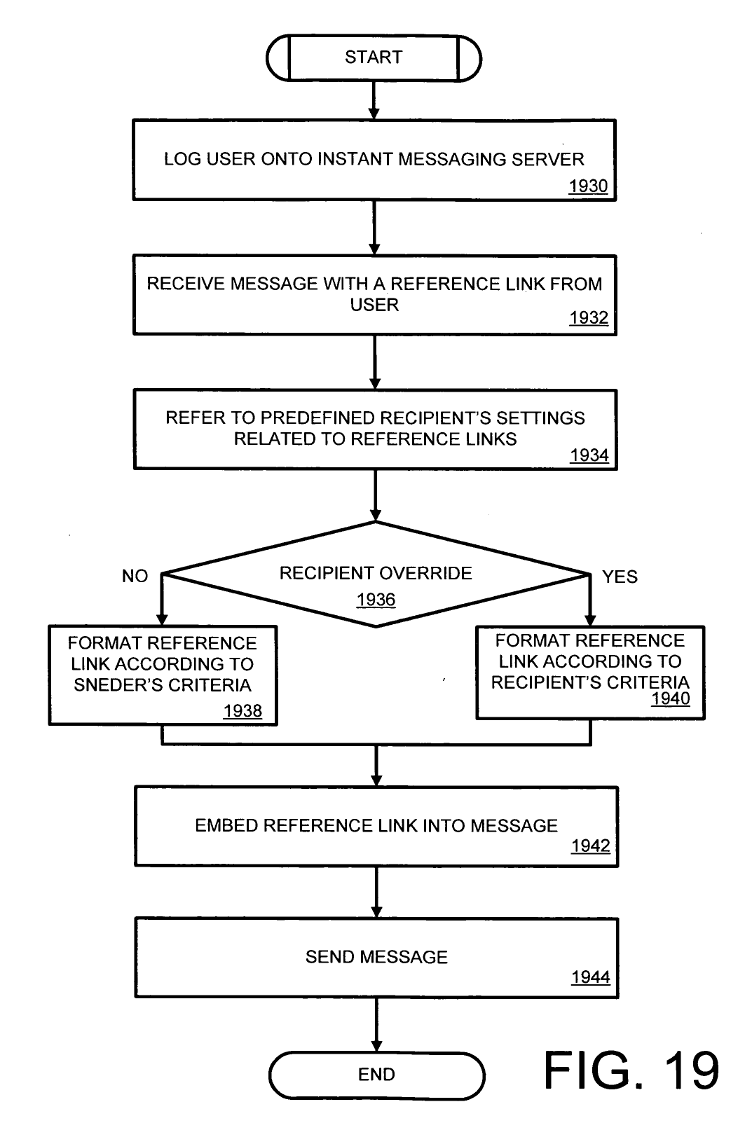

FIG. 19 is a flowchart illustrating exemplary steps that can be taken in providing a reference link with an instant message, similar to FIG. 4.

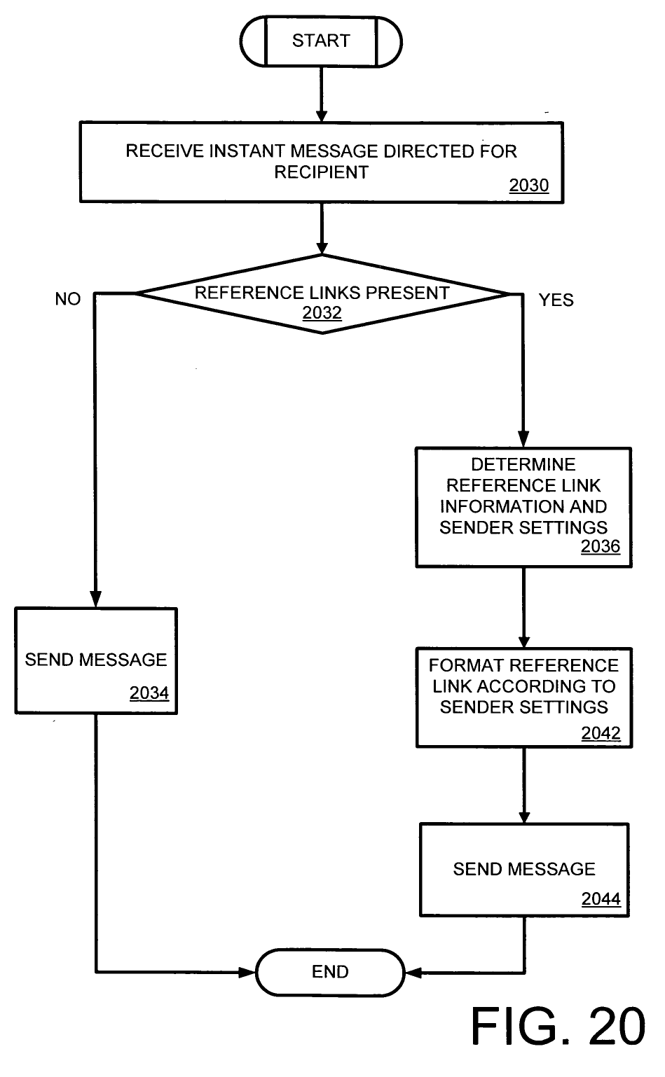

FIG. 20 is a flowchart illustrating exemplary steps that can be taken in sending an instant message that includes a reference link, such as the reference link from FIG. 4.

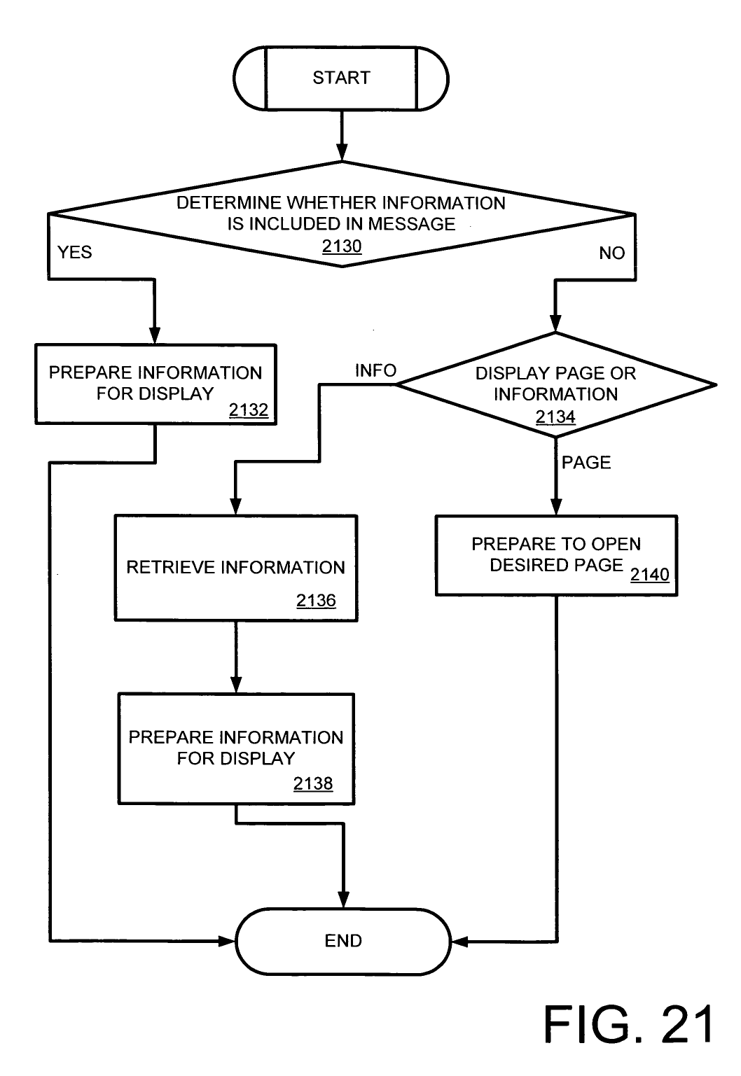

FIG. 21 is a flowchart illustrating exemplary steps that can be taken by a recipient's instant messaging client software when receiving an instant message and reference link, similar to the reference link from FIG. 4.

### DETAILED DESCRIPTION

FIG. 1 is a functional diagram of an exemplary instant messaging network environment. As illustrated, a plurality of users may be connected via an external network such as the Internet 100 or other communications network. The users may access the Internet 100 via client devices 106a (via wireless access point 108a), 106b (via wireless access point 108b), 106c, and 106d. The client devices may include, for example, portable communication devices 106a and 106b, a local network 106c and/or a personal computer 106d. It should be appreciated that the external network, client devices and connections illustrated in FIG. 1 are shown by way of example, but this disclosure is not limited to these examples. The disclosure may be applicable to any client device, connection, and external network that supports instant messaging. Additionally included in this nonlimiting example is a server 102 that is coupled to a data storage unit 104.

During an instant messaging session, a user may activate instant messaging client software that is stored on the user's client device 106a. Activation of the instant messaging client software can facilitate a connection request with the server 102, which may be a dedicated instant messaging server. The server 102 can then authenticate the user via any of a number of authentication techniques including, but not limited to technologies related to a user identification (userid) and password (userpw) and various biometric authentication processes. According to an exemplary embodiment, the authentication process includes the server 102 (or other server) receiving data (such as a userid and userpw) and comparing that data with data stored on data storage 104 (which can include data storage logic, a database, authentication server, or any permutation of these). If the data submitted by the user matches the data stored in data storage 104, the user can be authenticated, and granted access to instant messaging services.

Once the user has been authenticated, the user can send an instant message to any of his or her contacts (e.g., persons to whom the user communicates). According to an exemplary embodiment, the user can send an instant message to anyone who has an account with the server 102. If the user knows the desired recipient's account name associated with the server 102, the user can send an instant message to that recipient. Additionally, in many circumstances, the user will have the user's contacts saved on instant messaging client software or on the server 102 such that the user does not have to know and re-enter the account name, handle, or instant message identification (IMID) each time the user wishes to send an instant message.

Additionally, the server 102 can keep track of the various users that are currently logged onto the server, and provide presence information regarding the user's contacts. Thus, if a user wishes to send an instant message to a recipient, the server 102 can send information as to whether that contact is currently logged onto the server. Upon receiving presence data related to the user's contacts, the user can send an instant message to a recipient (whose presence is known), thereby beginning an instant messaging chat session. While the server 102 can monitor presence data for each user associated with the server 102, other implementations can provide that logic on user device 106 determines the user's presence. The user's client device 106 can then communicate this data to the server 102 for transmission to other users.

In at least one instant messaging environment, each message sent between the user and the contact can be communicated through the server 102. In such a scenario, the user at client device 106a can compose and send an instant message that is directed from the user's client device 106a to the wireless access point 108a, and then to the Internet 100. The message can then be sent to the server 102 back through the Internet 100 to the recipient's client device 106b. Other embodiments can provide that the server initiates a communication between users, however once the communication is established, the server is removed from the communication such that the users can communicate directly.

Additionally, one should note that while some instant messaging environments have a dedicated instant messaging server (or servers), others may use general purpose devices of varying capabilities to manage instant messaging traffic as well as perform other tasks. Further, while this nonlimiting example discusses a proprietary instant messaging environment, one should note that this disclosure also contemplates an environment utilizing a universal instant messaging protocol, or a communications environment that facilitates communication across a plurality of different instant messaging services using a plurality of different instant messaging protocols.

FIG. 2 is a functional diagram of an exemplary local network environment by which a user can send an instant message, similar to the environment from FIG. 1. The local network environment of FIG. 2 can be a home network, a business network or other network configured to facilitate communication between users. As illustrated, client devices 106e, 106f, 106g are coupled to a local router 210. This coupling may be wire-line or wireless. Though depicts ad personal computers, the client devices 106e, 106f, and 106g may be implemented with any device capable of supporting instant messaging in a local network. Although two local servers are shown in FIG. 2 for illustrative purposes, it will be appreciated that there may be more ore fewer than two local servers. The local router is coupled to local server 202a and local server 202b. The local servers 202a, 202b (collectively referred to as local server 202) are coupled to local data storage 204. The local servers 202 are also coupled to an external network, such as the Internet 100.

In this exemplary networking environment a user located at client device 106e may desire to send an instant message to a recipient located at client device 106g. In the networking environment of FIG. 2, the user at client device 106e can compose and send the instant message via client software stored on the client device 106e. The message can then be sent from the client device 106e to the local router 210. The local router can then send the message to one of the local servers 202. The local server 202 can communicate the message back through the local router 210 to the intended recipient located at client device 106g.

As the nonlimiting example of FIG. 2 illustrates, in some embodiments instant messages can be sent internal to the local network, without the user of an external network, such as the Internet 100. As stated above, such a configuration may be desirable for a business that wishes to facilitate communication between employees, but not to the Internet community at large. Such a configuration may use its own instant messaging protocol, a universal instant messaging protocol, or a proprietary instant messaging protocol.

Additionally, while the configuration of FIG. 2 facilitates intra-network instant messaging, this configuration can also facilitate inter-network instant messaging, similar to the configuration from FIG. 1. In such a scenario, a user operating client device 106f can send and receive messages to a contact that is not located within the local network of FIG. 2. The message can be sent through local router 210 to local server 202. From local server 202, the message can be sent to an external network, such as the Internet 100.

Referring back to FIG. 1, the message can then be sent from the network 106c to server 102 (which is not part of the local network in FIG. 2), and then back through the Internet 100 to client device 106b. The contact that is operating client device 106b can then reply through the same channels. More specifically, the reply message can be sent from 106b through the Internet 100 to the server 102, back through the Internet 100, to the network 106c (to FIG. 2), to the local server 202, through the local router 210, and back to the user at client device 106f.

One should note that the configuration of FIG. 2 is a nonlimiting example. Components can be added or removed (or both) without diverging from the scope of this disclosure. Additionally, although the configurations from FIGS. 1 and 2 are illustrated as various examples of an instant messaging configuration, these are not meant to be limiting. More specifically, in at least one configuration, instant messages sent between unrelated users need not use the Internet 100. Two users that are engaged in an instant messaging chat session on the same Internet Service Provider (ISP) may not require the use of the Internet 100 to facilitate the communication. As the ISP can link a user to the Internet 100, two users operating on the same ISP may simply use the ISP to facilitate the communication. In such a scenario, the configuration of FIG. 2 becomes more applicable, even for users who are not otherwise related. Additionally, if a company has multiple offices, use of the Internet 100 for instant messaging communications may be desired, and may be implemented similar to the configuration of FIG. 1.

FIG. 3 is a functional diagram illustrating an exemplary embodiment of a client device that may be configured to communicate via a communications network such as the networks from FIGS. 1 and 2. Although a wire-line client device is illustrated, this discussion can be applied to any device. According to an exemplary embodiment, in terms of hardware architecture, as shown in FIG. 3, the client device 106 includes a processor 382, volatile and nonvolatile memory 384, a display interface 394, data storage 395, and one or more input and/or output (I/O) device interface(s) 396 that are communicatively coupled via a local interface 392. The local interface 392 can include, for example but not limited to, one or more buses or other wired or wireless connections. The local interface 392 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 382 may be a hardware device for executing software, particularly software stored in volatile and nonvolatile memory 384.

The processor 382 can be any custom made or commercially available processor, a central processing unit (CPU), an auxiliary processor among several processors associated with the client device 106, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80×86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 384 can include any one or combination of volatile memory elements (e.g., random access memory (RAM, such as DRAM, SRAM, SDRAM, etc.)) and nonvolatile memory elements (e.g., ROM, hard drive, tape, CD-ROM, etc.). Moreover, the memory 384 may incorporate electronic, magnetic, optical, and/or other types of storage media. Note that the volatile and nonvolatile memory 384 can have a distributed architecture, where various components are situated remote from one another, but can be accessed by the processor 382.

The software in volatile and nonvolatile memory 384 may include one or more separate programs, each of which includes an ordered listing of executable instructions for implementing logical functions. In the example of FIG. 3, the software in the volatile and nonvolatile memory 384 may include instant messaging client software 399, as well as an operating system 386. A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet 100; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system 386 essentially controls the execution of other computer programs and provides scheduling, input-output control, file and data management, memory management, and communication control and related services.

A system component embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 384, so as to operate properly in connection with the Operating System 386.

The Input/Output devices that may be coupled to system I/O Interface(s) 396 may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

If the client device 106 is a personal computer, workstation, or the like, the software in the volatile and nonvolatile memory 384 may further include a basic input output system (BIOS) (omitted for simplicity). The BIOS is a set of software routines that initialize and test hardware at startup, start the Operating System 386, and support the transfer of data among the hardware devices. The BIOS is stored in ROM so that the BIOS can be executed when the client device 106 is activated.

When the client device 106 is in operation, the processor 382 is configured to execute software stored within the volatile and nonvolatile memory 384, to communicate data to and from the volatile and nonvolatile memory 384, and to generally control operations of the client device 106 pursuant to the software. Software in memory, in whole or in part, is read by the processor 382, perhaps buffered within the processor 382, and then executed.

FIG. 4 is an exemplary display for the instant messaging client software discussed with reference to FIGS. 1 and 2. As illustrated, the desktop display 470 can include a “START” button 472, an “INSTANT MESSAGING” taskbar menu item 474, an “EMAIL” taskbar menu item 476, an “INTERNET” taskbar menu item 478, and a Date and Time indicator 480. As one of ordinary skill in the art will understand, the taskbar menu items can be linked to various software programs that are currently open on the client device 106. As a nonlimiting example, the instant messaging client software 399, which can be configured to display a user interface, similar to instant messaging window 482, relates to the taskbar menu item 474. By selecting the “INSTANT MESSAGING” taskbar menu item 474, the user can display and remove the instant messaging window 482 from the desktop display 470.

As illustrated, the instant messaging window 482 includes a text prompt 484 for the user to enter a message. The input box 484 can be configured to display both outgoing messages and incoming messages. As such, a history (thread) of the current instant messaging session can be documented. The contact can be selected by the checkbox next to each contact in the contact section 486 of the instant messaging window 482. Additionally in contact section 486 is a presence icon associated with each contact. As discussed above, the server 102 can determine which users are currently logged onto the server and can display this information to contacts of that user. In this nonlimiting example, the contacts “Leigh,” “Rebecca,” and “Louise” are currently logged onto the server, while “Andrew” is not logged onto the server 102.

Additionally included in the instant messaging window 482 are a “REF LINK” option 494, an “OPTIONS . . . ” option 488, a “FONTS . . . ” option 490, and a “SEND” option 492. The “REF LINK” option 494 can provide the user with the ability to determine various settings with respect to reference links, as discussed below. The “OPTIONS . . . ” option 488 can provide the user with access to various options related to the display or functionality of the instant messaging Window 482, such as sending options, receiving options, presence options, etc. The “FONTS . . . ” option 490, on the other hand can provide the user with data related to previously monitored instant messaging usage. The “SEND” option 492 is an option configured to execute sending of a message to the recipient or recipients, in response to selection by a user.

Additionally included in the instant messaging window 482 of FIG. 4 is an instant message with an inserted reference link 496. In this nonlimiting example a user of the instant messaging logic 399 is composing an instant message to the contact “Leigh”. The user has input the message into text area 484. Included in the message is the reference link 496, which includes the symbol “BLS.” In this particular nonlimiting example, the instant messaging logic 399 is configured to place a visible dashed line around the symbol “BLS.” Additionally, various other actions can be performed based on the particular configuration of the instant messaging logic 399, as described in more detail below.

One should note that the instant messaging client software, which can be configured to display the user interface of FIG. 4 is included for purposes of illustration, not limitation. As is evident to one of ordinary skill in the art, any instant messaging logic can be used to facilitate communication of instant messages between a user and a recipient.

FIG. 5 is an exemplary display for the instant messaging client software with a reference link, such as the reference link from FIG. 4. The reference link may be associated with a company, for example BLS as illustrated in FIG. 5, where BLS is the stock trading symbol of BellSouth® Corporation. As illustrated, the user who composed the message (or a user that may be the recipient of the message) has “hovered” a cursor over the reference link denoted with “BLS.” Alternatively, the composed message may have included the term “BellSouth” instead of BLS. Any alias, symbol, or name can be associated with a reference link. “Hovering” can be seen as a user positioning a cursor over the reference link for a predefined period of time. In response to this action, the instant messaging client software 399 can be configured to display the current stock quote 592 for the entity BLS. According to the reference link, BLS stock is selling for $100.32.

Additionally, while in FIG. 5 the instant messaging client software 399 is configured to display the current stock quote, this is nonlimiting example. As discussed in more detail below, other information can be displayed in response to a user input (where the user input can include hovering the cursor over the symbol, double-clicking the reference link, single clicking the reference link, etc.), depending on the particular configuration and user settings. As a nonlimiting example, depending on the entity related to the reference link, the instant messaging client software 399 can be configured to display different types of information. More specifically, in the previous example, the entity BLS is included in the reference link. Because BLS is a business (entity type) the reference link can include information related to one or more of the following: a stock quote, an address, an email address, an instant messaging address, a web address, employment opportunities, and business profile. Other embodiments can, depending on the determined entity and entity type, display one or more of the following: a email address, a business address, a home address, a home telephone number, a business telephone number, a facsimile number, an instant messaging address, an employer, a job title, a birthday, and an anniversary Additionally, while in this nonlimiting example the instant messaging client software 399 is configured to perform an action in response to the user hovering the cursor over the reference link, this is also a nonlimiting example. As one of ordinary skill in the art will understand, other events can trigger a display of the desired information.

FIG. 6 is an exemplary display for the instant messaging client software in response to an event related to the reference link from FIG. 4. More specifically, an exemplary reference link detail window 682 can be displayed in response the instant messaging client software 399 receiving a user input such as “double clicking” the reference link 496 identified by the character string “BLS” from FIG. 4. Upon receiving the user input, the instant messaging client software 399 can open a reference link 496 detail window 682, which can include a title 688 and detailed information 690 regarding the reference link. As a nonlimiting example, the detailed information 690 can include the current price of BLS stock, the total volume, the 52-week high, the 52-week low, the opening price, the previous close price, the price per earnings of the stock (where user input can include hovering the cursor over the symbol, double clicking the reference link, single clicking the reference link, etc.). Additionally included in the reference link detail window 682 may be a “SEE CHART” option 692a, a “DETAILED INFO” option 692b, and a “NEWS ON BLS” option 692c.

One should note that in some embodiments the reference link detail window 682 can take the form of a website (or web page), however this is a nonlimiting example, and can contain a variety of information regarding the subject of the reference link, as well as a variety of manners of presenting such information. Additionally, depending on the particular configuration, the information displayed in the reference link detail window 682 can simply be information compiled by the instant messaging server 102 for display upon receiving a predetermined input from the user. More specifically, the instant messaging client software 399 on client device 106 or similar logic on instant messaging server 102 (or both) can provide that when the reference link “BLS” 496 is selected, a web page is opened up to display the detailed information from reference link detail window 682. Alternatively, selection of the reference link 496 can simply cause the instant messaging server 102 to retrieve the desired information for display on the user's client device 106.

Additionally, selection of the “SEE CHART” option 692a can open a window for a graphical representation of performance for the BLS stock (not shown). The graphical representation can include any of a plurality of timeframes, and can include stock price, volume, or other information that may be of interest to the user. In addition to the “SEE CHART” option 692a, the reference link detail window 682 can also include a “DETAILED INFO” option 692b, which can provide even more detailed information regarding BLS stock. Additional information can include earnings per share, dividend per share, total shares, etc. Also included is a “NEWS ON BLS” option 692c, which can provide the user with news related to BLS.

FIG. 7 is an exemplary display for instant messaging client software, similar to the display from FIG. 4. As illustrated, upon an event, such as user input (where user input can include hovering the cursor over the symbol, double clicking the reference link, single clicking the reference link, right clicking the reference link, etc.), the nonlimiting example of FIG. 7 provides a plurality of reference link options 792 related to the subject of the link, which may be a corporate entity, for a user to select. The options can include a stock quote, news, jobs, location, products and services, and a link to, in this example, the BLS website. The user can determine what type of BLS related information is communicated to the recipient of the instant message. More specifically, by selecting the “stock quote” option, the user can provide the recipient with a current stock quote (or link to the current stock quote) within the reference link. If the user selects “news,” the recipient can be provided with news related to BLS. The other options illustrated in FIG. 7 can be similarly applied to the instant message.

As is evident to one of ordinary skill in the art, other information could be displayed depending on the particular configuration, and desires of the user. As a nonlimiting example, if the subject of the reference link relates to a person, this data could include a web search of the person, an address, phone number, email address, etc. The user (sender or recipient) can determine the reference link options 792 that appear, and also the order in which the reference link options appear. Additionally, at least one of the selections appearing in the reference link options 792 may itself be a link to another window or dialog box containing more detailed information regarding the subject (for example, BLS, some other corporate entity, person, place, or thing).

FIG. 8 is an exemplary display of a plurality of personal reference link options associated with a subject that is a person, similar to the reference link options from FIG. 7. More specifically, the reference link 896 is associated with the name “John Doe.” Responsive to receiving user input related to the name “John Doe” (or any string of characters that the instant messaging software 399 recognizes as a name), the instant messaging software 399 can include a dashed line to indicate that this character string is associated with a reference link. Additionally, upon the user performing an action, such as hovering the cursor over the reference link (or “right-clicking,” selecting the “REF LINK” option, or other action), information regarding that person can be displayed. As a nonlimiting example, the instant messaging client software 399 may be configured to display a picture of the person, an image or avatar representing that person (not shown), or any other information upon performance of the user option. In another exemplary embodiment, an exemplary reference link detail window (not shown), similar to the one described in FIG. 6 can be displayed in response to the receipt of a user input. In yet another exemplary embodiment, a plurality of personal reference link options 898 can be displayed, as illustrated in FIG. 8. The exemplary personal reference link options 898 of FIG. 8 can include “send mail”, “include in an instant message”, “add to contacts”, “insert email address”, “insert instant messaging address”, and “an insert all information.” More specifically, the “send mail” personal reference link option 898 can provide the user with an option to send the person indicated in the reference link an email. The “include in IM” option can provide the user with a quick option to include John Doe as a recipient of the instant message in the text area of instant messaging window 482. The “add to contacts” option can provide the user (or the recipient or both) with the ability to add John Doe to the user's (or recipient's) list of contacts. The “insert email address” option can provide the user (or recipient or both) with the ability to associate John Doe's email address with the reference link 896. More specifically, upon selecting the “insert email address” option, and sending the instant message to a recipient, the recipient can access John Doe's email address. As with FIG. 7 above, one or more of the selections appearing in the reference link options 898 may itself be a link to another window or dialog box containing more detailed information regarding the subject (for example, his or her birthday, schools attended, etc.), in this nonlimiting example, a person.

Similar to the discussion in FIG. 6, a user (sender or recipient) may have the ability to determine the information that is communicated to the recipient and the order in which the information appears in the personal reference link option 898. In this nonlimiting example, the user can determine what information about John Doe is communicated to the recipient. Additionally, the subject John Doe may also be a “Celebrity John” or “Celebrity Jane,” where Celebrity John and Celebrity Jane may be the name, nickname, or alias of a past or present celebrity or public figure. Here the reference link associated with the celebrity (who may be a television star, movie star, sports figure, or public figure) may lead to such information as the celebrity's biography, personal likes/dislikes whereabouts, filmography, current news, blog, or other information of interest.

FIG. 9 is an exemplary display of a reference link options page that can be accessed by selecting the “REF LINK” option from FIG. 4. As illustrated, the reference link window 982 can include a “when sending reference link” option 984. This option can provide a user with the ability to determine what information is associated with a reference link. Choices include an “always send primary” option 992a, a “prompt” option 992b, a “customize according to specific reference link” option 992c, and a “customize according to recipient” option 992d. Selecting the “always send primary” option 992a can provide that when a reference link is created, “primary” data is always included. “Primary” data can be determined by an instant messaging administrator, the user, or a third party, but can generally be regarded as data a user would most likely desire to include in a reference link. While some configurations can determine that primary data is an email address for a personal reference link and a stock quote for a business reference link, other data may be supplemented to or substituted for this data

Another option in the “when sending reference link” option 984, is a “prompt” option 992b. The “prompt” option 992b can be configured to prompt the user for the desired information to be included in the reference link. This can provide the user with the ability to specifically determine the information communicated to a recipient for each message. If the user desires that an email is included in a first reference link, and a home address in a second reference link, the user's instant messaging client software 399 can be configured to provide this option by prompting the user for each reference link.

Another option under the “when sending reference link” option 984 is the “customize according to the specific reference link” option 992c. This option provides the user an option to automatically determine that when a certain type of reference link is created, certain information is always associated with that type of reference link. More specifically, the user can determine that whenever a personal reference link is created, a home address is always included, but when an address is created as part of a reference link, an email address is associated with the reference link. Additionally, this option can provide for more specific customization. More specifically, the user can determine that if the character string “John Doe” is created as a reference link, the information communicated to the recipient is always John's email address. Other customizations can also be included and are considered within the scope of this disclosure.

An additional option in the “when sending reference link” option 984 is the “customize according to recipient” option 992d. With this option, the user can specifically determine that whenever sending an instant message to a certain contact, an address is also included in the reference link. As a nonlimiting example, if the user is composing a message to “Leigh” and the message includes the reference link “John Doe” (or any personal reference link, depending on the configuration), the instant messaging client software 399 can determine that the user will always want John's email address included with the reference link. However, the user may designate that when an instant message is sent to “Andrew” with the reference link “John Doe,” John's home address is provided with the reference link.

As one will realize, the “customize according to recipient” option 992d and the “customize according to reference link” option 992c can be used together. More specifically, the user may want to display an email address when sending instant messages to Leigh, but only when the reference link refers to a person. When the instant message is to sent Leigh, and the reference link is a publicly traded company, the user may want to always include a chart of the stock performance of that company. However, for other recipients, the user may want to display different information.

Also included in the reference link options window 982 is a “show information” option 986. The “show information” option 986 can provide the user with the ability to view the reference link information (illustrated in FIG. 4) always, on “hover,” or on right click. Additionally included in the reference link options window 982 is an information display option 988. The information display option 988 can provide the user (or recipient) with the option to view detailed information as shown in FIG. 4, or as shown in FIG. 5. More specifically, the user can determine whether the information is displayed as a miniature window on the cursor, or whether selection of the reference link opens a web page to the desired information. Additionally, depending on the configuration, the user can determine how this information is displayed to the recipient. Also included in the nonlimiting example of FIG. 9 is a save settings option 990 that can provide the user to save the selected options described above.

FIG. 10 is an exemplary display of a reference link options page to a recipient window, similar to the display from FIG. 9. More specifically, while option 992d allows for customization of reference links to a recipient, the options of FIG. 10 provide the user with the ability to set that customization. As shown, the reference link options to Leigh window 1082 can provide the user with the ability to determine how information is sent in a reference link to the particular recipient (in this nonlimiting example, Leigh). The user can be provided with similar options as illustrated in FIG. 9, except that the “when sending reference link” option 1084, the “show information link” option 1086, and the “information display” option 1088 apply only to the specific recipient (in this case Leigh). Also included in the reference link options to Leigh window 1082 is a save settings option 1090.

FIG. 11 is an exemplary display of a reference link option for a reference link window, as shown in the display from FIG. 9. More specifically, the reference link options when sending BLS window 1182 can provide the user with the ability to determine how information is sent in a particular reference link (in this nonlimiting example, BLS). More specifically, this display provides the user with options that are specific to the reference link “BLS.” As shown, the user can be provided with similar options as illustrated in FIG. 10, except that the “when sending reference link” option 1184, the “show information link” option 1186, and the “information display” option 1188 apply only to the specific reference link included in the instant message (in this case BLS). Also included in the “reference link options when sending to BLS” window 1182 is a save settings option 1190.

FIG. 12 is an exemplary display of a reference link options page when sending particular information window, similar to the display from FIG. 11. More specifically, the reference link options when sending a contact window 1282 can provide the user with the ability to determine how information is sent in a reference link when the reference link includes specific information (in this nonlimiting example, contact information, which can include an address, email address, instant messaging address, where user input can include hovering the cursor over the symbol, double-clicking the reference link, single clicking the reference link, etc.). As shown, the user can be provided with similar options as illustrated in FIG. 9, except that the “when sending reference link” option 1284, the show information link 1286, and the information display option 1288 apply only to when the user is sending particular information (in this case contact information). Also included in the “reference link options to a contact” window 1282 is a save settings option 1290.

FIG. 13 is an exemplary display of an instant messaging window for a instant message recipient, similar to the instant messaging window from FIG. 4. As shown in text area 1384 of instant messaging window 1382, the recipient has received an instant message from “User” that includes a reference link 1396 that is associated with John Doe. Also included in the instant messaging window 1382 is a “REF LINK” option 1394, an “OPTIONS . . . ” option 1388, a “FONTS . . . ” option 1390, and a “SEND” option 1392. Similarly, presence information 1386 of the recipient's contacts is also included.

One should note that the instant message could include information that is related to the reference link 1396. More specifically, if the user (sender) specified that the reference link in this instant message includes John Doe's email address, the email address can be included in the instant message. When the recipient hovers (or otherwise causes an event that facilitates display of the reference link information), John Doe's email address can be displayed.

In other embodiments, the reference link 1396 that includes the character string “John Doe” can simply provide a way for the recipient's instant messaging client software 399 to locate the desired information. In such a configuration, John Doe's email address may be located in the instant messaging server 102, data storage 104, is otherwise available over an external network, such as the Internet. Additionally, other embodiments can provide that the recipient's instant messaging client software 399 can search the recipient's client device 106 for the information. If the recipient's client device cannot locate the desired information, a request can then be sent (to the user, server 102, or other entity) for the desired information. Also included is a reply 1392 to the received instant message by the recipient.

FIG. 14 is an exemplary display for the instant messaging client software, similar to the display from FIG. 8. More specifically, the reference link 1396 is associated with the name “John Doe.” Responsive to receiving user input related to the name “John Doe” (or any string of characters that the instant messaging software 399 recognizes as a name), the recipient's instant messaging client software 399 can include a dashed line to indicate that this is a reference link. Additionally, upon the recipient performing an action, such as hovering the cursor over the reference link (or “right-clicking,” selecting the “REF LINK” option, or other action) a plurality of personal reference link options 1496 can be displayed. The personal reference link options 1496 for FIG. 14 include “send mail,” “include in an instant message,” “add to contacts,” “view email address,” “view instant messaging address,” and “view all information.”

More specifically, the “send mail” personal reference link option 1496 can provide the recipient of an instant message with an option to send the person indicated in the reference link an email message. The “include in IM” option can provide the recipient with a quick option to include John Doe as a recipient of the current instant message. The “add to contacts” option can provide the recipient with the ability to add John Doe to the recipient's list of contacts. The “view email address” option can provide the recipient with the ability to view John Doe's email address that is available about John Doe. The “view IM address” option can provide the recipient with the ability to view John Doe's instant messaging address. The “view all contact information” option can provide the recipient to view all contact information available about John Doe. While the information about John Doe may be provided with the reference link, this is not, a requirement. As one of ordinary skill in the art will understand, this information can be retrieved from other sources.

One should note that although similar to the configuration from FIG. 8, the options illustrated in FIG. 14 may or may not be the same as the options from FIG. 8. Depending on the particular configuration and particular instant messaging client software 399 on the user's client device 106 and the recipient's client device 106, different options may be provided. One should also note the in some embodiments the recipient can simply view the information included in the reference link by “hovering” over the reference link. As a nonlimiting example, if the user includes John Doe's email address in the reference link 1396, the recipient can simply view the email address by “hovering” the cursor over the reference link. By “right clicking” (or other action) the recipient can then be provided the options of FIG. 14. As one of ordinary skill in the art will understand, depending on the particular embodiment, other user actions can be used to activate these features.

FIG. 15 is an exemplary display of a reference link options page that can be accessed by the recipient selecting the “REF LINK” option from FIG. 13. As illustrated, the reference link window 1582 can include a “when receiving reference link” option 1584. This option can provide the recipient with an “only receive new or different info” option 1592a, an “always show email address” option 1592b, a “customize according to specific reference link” option 1592c, and a “customize according to sender” option 1592d. The “only receive new or different info” option can provide to the recipient the ability to only receive information that the recipient's client device 106 does not already have. As a nonlimiting example, when an instant message is received, the recipient's client device 106 can determine information related to the reference link. If the reference link refers to information that the recipient's client device 106 already has, the recipient's instant messaging client software 399 can automatically send a reply to the instant messaging server 102 or sender's instant messaging client software 399 that the information need not be sent. The desired information can then be accessed locally on the recipient's client device 106 to be displayed for the recipient.

The next option provided in the “when receiving reference link” option 1584 is the “always show email address” option 1592b. This option can provide the user with the ability to override the sender's desires and always show an email address associated with the reference link. Other embodiments can also provide similar options related to phone numbers, addresses, websites, and other information that the recipient may always desire to receive.

Additionally, the “when receiving reference link” option 1584 also includes a “customize according to reference link” option 1592c. This option can provide the recipient of instant messages with the ability to determine the type of information received with a particular or particular type of reference link. More specifically, the recipient can determine that whenever receiving an instant message that includes a reference link related to “BLS” the recipient's instant messaging client software 399 will display a telephone number.

An additional option in the “when receiving reference link” option 1584 is the “customize according to sender” option 1592d. More specifically, with this option the recipient can specifically determine that whenever receiving an instant message from a particular person, certain data is included in the reference link, regardless of the information provided by the sender. As a nonlimiting example, a recipient can determine that any message received from “Leigh” that includes a reference link, also includes an email address related to the person or entity to which the reference link refers.

As one will realize, “customize according to sender” option 1592d and the “customize according to reference link” option 1592c can be used together. More specifically, the recipient may want to display an email address when receiving instant messages from Leigh, but only when the reference link is a person. When an instant message is received from Leigh, and the reference link is a publicly traded company, the recipient may want to always include a chart of the stock performance of that company. However, for other senders, the recipient may want to display different information.

One should also note that while the sender of an instant message and reference link may determine information in the link, in some embodiments, the recipient can override the designation by the sender and display information most desirable to the recipient. This option can depend on whether the recipient has access to the desired information. More specifically in one nonlimiting example, a recipient can designate that when receiving a reference link to a person, the recipient desires that the person's email address is always displayed. If the recipient receives an instant message with a reference link to John Doe, but the reference link only includes John's instant messaging address, the recipient may access John's email address in order to display this information. If the information is not available, the recipient's instant messaging client software can display no information, display the information designated by the sender, or provide other information designated by the recipient.

Also included in the reference link options window 1582 is a “show information” option 1586. The “show information” option can provide the user with the ability to view the reference link information (illustrated in FIG. 4) always, on “hover” or on right click. Additionally included in the reference link options window 1582 is an information display option 1588. The information display option 1588 can provide the recipient with an option to view detailed information as shown in FIG. 4, or as shown in FIG. 5. More specifically, the recipient can determine whether the information is displayed as a miniature window on the cursor, or whether selection of the reference link opens a web page to the desired information. Additionally, depending on the configuration, the recipient can determine how this information is displayed. Also included in the nonlimiting example of FIG. 15 is a save settings option 1590 that can provide the recipient an option to save the selected options described above.

FIG. 16 is an exemplary display of a reference link options page from a sender window, similar to the display from FIG. 15. More specifically, the reference link options from Leigh window 1682 can provide a recipient with the ability to determine the information displayed in an instant message from a particular sender (in this nonlimiting example, Leigh). As shown, the recipient can be provided with similar options as illustrated in FIG. 15, except that the “when receiving reference link” option 1684, the “show information link” option 1686, and the “information display” option 1688 apply only to the specific sender (in this case Leigh). Also included in the reference link options from Leigh window 1682 is a save settings option 1690.

FIG. 17 is an exemplary display of a reference link options page from a sender window, similar to the display from FIG. 16. More specifically, the reference link options when receiving BLS window 1782 can provide a recipient with the ability to determine information that is displayed when an instant message includes a particular reference link (in this nonlimiting example, BLS). As shown, the recipient can be provided with similar options as illustrated in FIG. 16, except that the “when receiving reference link” option 1784, the “show information link” option 1786, and the “information display” option 1788 apply only to the specific reference link included in the instant message (in this case BLS). Also included in the reference link options when receiving BLS window 1782 is a save settings option 1790.

FIG. 18 is an exemplary display of a reference link option when receiving particular information window, similar to the display from FIG. 17. More specifically, the reference link options when receiving a contact window 1882 can provide the recipient with the ability to determine information that is displayed in a reference link when the reference link includes specific information (in this nonlimiting example, contact information). As shown, the recipient can be provided with similar options as illustrated in FIG. 17, except that the “when receiving reference link” option 1884, the “show information link” option 1886, and the “information display” option 1888 apply only to when the user is sending particular information (in this case contact information). Also included in the reference link options when receiving a contact window 1882 is a save settings option 1890.

As a nonlimiting example, the recipient can be provided with the reference link options when sending a contact window. This window can provide that the recipient can determine exactly how information from a reference link is displayed when the information relates to a contact of the recipient. The recipient can specify that when a contact is being specified in the reference link, information that is new or different than the information that is already included on the recipient's client device 106 is displayed. Alternatively, the user can indicate that the recipient's instant messaging client software 399 always display the contact's email address. Additionally the user can customize according to the sender or according to the contact in the reference link (or both).

FIG. 19 is a flowchart illustrating exemplary steps that can be taken in providing a reference link with an instant message, similar to FIG. 4. As illustrated, the first step of the flowchart in FIG. 19 is to log the user onto the instant messaging server 102 (block 1930). As one of ordinary skill in the art will realize, logging a sender onto the instant messaging server 102 can include receiving a USERID and password (or otherwise authenticating the sender). Once the sender has been authenticated, the instant messaging server 102 can provide the sender with various instant messaging services. Next, the instant messaging server 102 can receive a message that includes a reference link from the sender (block 1932). As described above, the reference link can include a person, company, address, email address, instant messaging address, website, or other information. Next, the instant messaging server can refer to predefined sender settings related to reference links (block 1934). More specifically, the instant messaging server 102 can periodically determine the sender's instant messaging settings such that messages can be formatted according to those settings. With reference links, the instant messaging server 102 can determine the settings described above to determine formatting for this particular recipient.

Next, the instant messaging server 102 can determine whether the settings included in the instant message conflict with the recipient's instant messaging settings and if so, whether the recipient desires to override the settings determined by the sender (block 1936). If the recipient does not want to override the settings defined by the sender, the instant messaging server 102 can format the reference link according to the sender's criteria (block 1938). If, on the other hand, the recipient does want to override the sender's settings, the instant messaging server 102 can format the reference link according to the recipient's criteria (block 1940). The instant messaging server 102 can then embed the reference link into the message (block 1942), and send the message (block 1944).

One should note that while FIG. 19 is discussed with reference to actions performed by the instant messaging server 102, one or more of these steps could also be performed by the recipient's instant messaging client software. In some embodiments, the instant messaging server 102 may not be configured for determining settings related to the sender's and recipient's client devices 106. Other embodiments may simply find that these steps can be more easily performed on the instant messaging client software 399. In any event, one should note that the steps can be performed at the instant messaging server 102, the instant messaging client software 399, or both.

FIG. 20 is a flowchart illustrating exemplary steps that can be taken in sending an instant message that includes a reference link, such as the reference link from FIG. 4. The first step in the flowchart of FIG. 20 is for the sender's instant messaging client software 399 to receive an instant message directed for a recipient (block 2030). Next, the sender's instant messaging client software 399 can determine if there is a reference link present in the message (block 2032). If there is no reference link associated with the message, the instant messaging client software 399 can send the message for delivery to the recipient's client device 106 (block 2034). If, on the other hand, there is at least one reference link associated with the message, the sender's instant messaging client software 399 can determine reference link information, and sender settings (block 2036). The reference link information can include information related to whether the reference link refers to a person, business, email address, website, or other type of data. Sender settings can include information regarding the sender's desired formatting of the reference link information. More specifically, the sender's settings can include whether to include a stock quote, location, job opportunities, company information, home address or other information related to the reference link (as stated above, this information can depend on the type of reference information).

Once the reference link information and sender settings are determined, the instant messaging client software 399 can format the message and reference link according to the information and settings (block 2042). This step can include providing information in the header of the message such that a recipient's instant messaging client software 399 can determine where to find the information in the reference link and how to present the information to the recipient. Other embodiments can include determining a website that includes the desired information, accessing the website, and retrieving the information for display. Still other embodiments can include providing the website for the recipient to simply access the desired website to obtain the desired information. Once the reference link and instant message are formatted according to the sender settings, the message can be sent for delivery to the recipient (block 2044).

One should note that some embodiments can include determining a desired format for the recipient. Because the sender and recipient may be communicating via instant messaging client software 399 that may or may not be compatible, such a determination could be desired in some scenarios. Additionally, other formatting may also be desired (and within the scope of this disclosure) in situations where the sender and recipient are communicating in incompatible instant messaging protocols. One should also note that while the description with respect to FIG. 20 relates to steps that can be performed by the instant messaging client software 399, other embodiments can include one or more of these steps being performed by the instant messaging server 102.

FIG. 21 is a flowchart illustrating exemplary steps that can be taken by a recipient's instant messaging client software when receiving an instant message and reference link, similar to the reference link from FIG. 4. The first step in the flowchart of FIG. 21 is to determine whether the reference link information is included in the message or whether the reference link only includes a pointer for finding the desired information (block 2130). More specifically, in some scenarios the sender of an instant message with a reference link may actually include the desired information within the message. The information can be included as part of the header, or as an attachment to the message body. Regardless, if the information can be provided with the instant message, the recipient's instant messaging client software 399 can prepare the information for display according to the settings and the information included with the reference link (block 2132).

If the information is not included with the message, a determination can be made as to whether the recipient's settings (or depending on the configuration, the sender's settings) dictate the information to be displayed, or whether a webpage with the desired information is to be displayed (block 2134). If the information is to be displayed, the recipient's instant messaging client software 399 can retrieve the desired information (block 2136), and prepare (block 2138) the information for display.

Alternatively, if the reference link is configured such that a web page that includes the information is to be displayed, the recipient's instant messaging client software 399 can prepare to open the referenced web page when the recipient tries to access the reference link (block 2140).

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CD-ROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method for including a reference link in an instant message, the method comprising:
receiving an identifiable character string in the instant message, the identifiable character string being associated with an entity;
determining an entity type that is associated with the entity;
retrieving information related to the entity;
creating a reference link that associates the identifiable character string with the information related to the entity; and
including the reference link in the instant message.

2. The method of claim 1, wherein the entity type includes at least one of the following: a person, an address, a business, a location, a landmark, a telephone number, an email account, an instant messaging account, and a web address.

3. The method of claim 1, wherein including reference link in the instant message includes at least one of the following: including information related to the entity and including a direction for retrieving information related to the entity.

4. The method of claim 1, wherein the information related to the entity includes at least one of the following: an email address associated with the entity, a stock quote associated with the entity, a phone number associated with the entity, an instant messaging account associated with the entity, an address associated with the entity, a location associated with the entity, and a name associated with the entity.

5. The method of claim 2, further comprising providing an option to include different types of information related to the entity depending on the determined entity type.

6. The method of claim 5, wherein in response to a determination that the entity is a business, including at least one of the following in the instant message: a stock quote, an address, an email address, an instant messaging address, a web address, employment opportunities, and business profile.

7. The method of claim 5, in response to a determination that the entity is a person, including at least one of the following in the instant message: a email address, a business address, a home address, a home telephone number, a business telephone number, a facsimile number, an instant messaging address, an employer, a job title, a birthday, and an anniversary.

8. A computer readable medium having a program for including a reference link in an instant message, the computer readable medium comprising:
logic configured to receive an identifiable character string in the instant message, the identifiable character string being associated with an entity;
logic configured to determine an entity type that is associated with the entity;
logic configured to retrieve information related to the entity;
logic configured to create a reference link that associates the identifiable character string with the information related to the entity; and
logic configured to include the reference link in the instant message.

9. The computer readable medium of claim 8, wherein the entity type includes at least one of the following: a person, an address, a business, a location, a landmark, a telephone number, an email account, an instant messaging account, and a web address.

10. The computer readable medium of claim 9, the program further comprising logic configured to provide an option to include different types of information related to the entity depending on the determined entity type.

11. The computer readable medium of claim 10, wherein in response to a determination that the entity is a business, including at least one of the following in the instant message: a stock quote, an address, an email address, an instant messaging address, a web address, employment opportunities, and business profile.

12. The computer readable medium of claim 10, wherein in response to a determination that the entity is a person, including at least one of the following in the instant message: a email address, a business address, a home address, a home telephone number, a business telephone number, a facsimile number, an instant messaging address, an employer, a job title, a birthday, and an anniversary.

13. The computer readable medium of claim 8, wherein including reference link in the instant message includes at least one of the following including information related to the entity and including a direction for retrieving information related to the entity.

14. The computer readable medium of claim 8, wherein the information related to the entity includes at least one of the following: an email address associated with the entity, a stock quote associated with the entity, a phone number associated with the entity, an instant messaging account associated with the entity, an address associated with the entity, a location associated with the entity, and a name associated with the entity.

15. A method for receiving an instant message that includes a reference link, the method comprising:
receiving the instant message;
determining that the instant message includes a reference link;
in response to determining that the instant message includes a reference link, denoting the reference link;
determining whether information related to the reference link is included in the instant message; and
displaying at least a portion of the information related to the reference link.

16. The method of claim 15, further comprising, in response to determining that information related to the reference link is included in the instant message, displaying at least a portion of the information related to the reference link.

17. The method of claim 15, further comprising determining whether the instant message includes an instruction for retrieving information related to the reference link.

18. The method of claim 17, wherein the instruction includes a location for retrieving the information related to the reference link.

19. The method of claim 15, further comprising determining whether there is a desire to override at least one parameter related to the received reference link.

20. The method of claim 15, further comprising displaying at least a portion of the information in the reference link in response to receiving user input to view the information related to the reference link.
